(19) United States
(12) Patent Application Publication
(10) Pub. No.: US 2020/0337502 A1
(43) Pub. Date: Oct. 29, 2020

(54) FOOD SHREDDING SYSTEM

(71) Applicant: Genius GmbH, Limburg (DE)

(72) Inventor: Cedomir REPAC, Brechen (DE)

(21) Appl. No.: 16/849,395

(22) Filed: Apr. 15, 2020

(30) Foreign Application Priority Data
Apr. 17, 2019 (LU) 101188

(51) Int. Cl. A47J 43/25; B26D 3/28

(52) U.S. Cl. CPC A47J 43/25; B26D 3/283; B26D 2003/285; B26D 2003/287; B26D 2003/288

(57) ABSTRACT

The invention relates to a foodstuff comminution system having a foodstuff comminution device having a main part which has a receptacle for a cutter part, and having an activation part which is connected in an articulated manner to the main part and which, for squeezing foodstuff material to be comminuted through a cutter part inserted in the receptacle, is pivotable from a placing position towards the cutter part to a closing position and subsequently from the closing position back to the placing position. The foodstuff comminution system is distinguished by an additional comminution tool which is capable of being secured in an operating position on the foodstuff comminution device, wherein the additional comminution tool in the operating position, conjointly with at least one component of the foodstuff comminution device, forms a mandolin slicer or a grater and the foodstuff comminution device provides a sliding track, or at least one part of the sliding track, of the mandolin slicer or of the grater, foodstuff material which is to be comminuted by means of the mandolin slicer or the grater being capable of being guided back and forth on said sliding track.

### CROSS-REFERENCE TO RELATED APPLICATION

The present application claims the benefit of and priority to Luxembourgian Patent Application No. 101188, filed Apr. 17, 2019, the entire disclosure of which is incorporated herein by reference.

### FIELD

The disclosure relates to a foodstuff comminution system having a foodstuff comminution device having a main part which has a receptacle for a cutter part, and having an activation part which is connected in an articulated manner to the main part and which, for squeezing foodstuff material to be comminuted through a cutter part inserted in the receptacle, is pivotable from a placing position towards the cutter part to a closing position and subsequently from the closing position back to the placing position.

### BACKGROUND

A foodstuff comminution device which is configured as a hand-held apparatus and which has two handle parts is known from DE 10 2007 042 660 A1. A press die is disposed on one handle part, and a cutter part is disposed on the other handle part. The cutter part has a cutting blade assembly by means of which the foodstuff material can be cut into strips. Similar apparatuses are known from US 2014/0190019 A1, DE 102 42 651 A1, and from EP 1 874 508 Bl. The potential applications of foodstuff comminution devices of this type are limited.

### SUMMARY

It is therefore the object of the present disclosure to set forth a foodstuff comminution system which is capable of flexible use and offers further potential applications.

The object is achieved by a foodstuff comminution system of the type mentioned at the outset, said foodstuff comminution system being characterized by an additional comminution tool which is capable of being secured in an operating position on the foodstuff comminution device, wherein the additional comminution tool in the operating position, conjointly with at least one component of the foodstuff comminution device, forms a mandolin slicer or a grater and the foodstuff comminution device provides a sliding track, or at least one part of the sliding track, of the mandolin slicer or of the grater, foodstuff material which is to be comminuted by means of the mandolin slicer or the grater being capable of being guided back and forth on said sliding track.

On account of the additional comminution tool which is capable of being coupled to the foodstuff comminution device, the disclosure offers the very particular advantage that even such foodstuffs which cannot at all be comminuted according to the principle of being squeezed through a cutter mesh, or not be comminuted according to said principle without having previously being divided into suitable pieces, can be comminuted. For example, an entire cucumber or an entire zucchini can be readily comminuted by means of an additional comminution tool configured as a mandolin slicer or as a grater, without said cucumber or zucchini prior thereto having to be cut into pieces.

The disclosure moreover has the very particular advantage that, in addition to the type of comminution according to the principle of being squeezed through a cutter mesh, other types of comminution such as, for example, grating or mandolin slicing, can be made available to the user.

The coupling capability of the additional comminution tool to the foodstuff comminution device can be implemented in very different ways. Those embodiments in which the additional comminution tool is capable of being secured on the foodstuff comminution device without the main part and/or the activation part to this end having previously to be modified or separated from one another are particularly advantageous.

In one particular embodiment the additional comminution tool in the operating position is capable of being secured in a non-destructive releasable manner on the foodstuff comminution device.

According to one particular aspect of the disclosure, the additional comminution tool can advantageously have a fastening portion as well as a tool portion.

It can particularly advantageously be provided (according to an independent aspect of the disclosure) that the fastening portion in the operating position is jammed in a form-fitting manner between the main part and the activation part, wherein the tool portion in the operating position is preferably disposed outside the receptacle.

It can in particular be very generally provided that the additional comminution tool is capable of being secured on the foodstuff comminution device in such a manner that the tool portion in the operating position is disposed outside the receptacle and outside the pivoting range of the activation part. In particular, such an embodiment is particularly advantageous when the foodstuff comminution device is configured as a hand-held apparatus.

In one advantageous embodiment, the activation part or the main part has a mating fastening means which is configured and specified for interacting with the fastening portion of the additional comminution tool so as to secure the additional comminution tool in the operating position on the activation part or on the main part. The mating fastening means can advantageously be disposed on the external side of the activation part that faces away from the main part, for example. However, the mating fastening means can also be disposed on another location of the activation part or on the main part.

For example, it can be advantageously provided that the fastening portion of the additional comminution tool and the mating fastening means conjointly form a bayonet connection. In one particular embodiment, a bayonet projection of the fastening portion of the additional comminution tool for coupling is introduced into a bayonet receptacle of the mating fastening means, and a relative rotation, for example by an angle in the range from 20 to 180 degrees, of the additional comminution tool relative to the foodstuff comminution device is subsequently carried out, on account of which threaded portions of the bayonet protrusion and of the bayonet receptacle are operatively connected and a fixed connection is established. In order for the additional comminution tool to be released from the foodstuff comminution device again, the user has to rotate the additional comminution tool relative to the foodstuff comminution device again, and can then retrieve the bayonet projection of the fastening portion from the bayonet receptacle of the mating fastening means again.

In one particularly advantageous embodiment, the mating fastening means has at least one, in particular elongate, recess, while the fastening portion has at least one, in particular elongate, carrier, which is/are configured and specified for being introduced in a form-fitting manner into the recess so as to secure the additional comminution tool in the operating position. In particular, it can be advantageously provided that the mating fastening means has precisely two elongate and mutually parallel recesses into which the fastening portion of the additional comminution tool that is formed by two elongate carriers can be plugged so as to secure the additional comminution tool on the foodstuff comminution device. In order for the additional comminution tool to be released from the foodstuff comminution device again, the user has only to extract the carriers from the recesses again.

As has already been mentioned, in one particularly advantageous embodiment the fastening portion in the operating position is jammed in a form-fitting manner between the main part and the activation part so as to secure the additional comminution tool on the foodstuff comminution device.

It can advantageously be provided in particular that the fastening portion is capable of being fitted into the receptacle, in particular in a form-fitting and/or latching manner. A fitting capability of the fastening portion in a form-fitting manner contributes towards safe and wobble-free anchoring in the operating position.

Alternatively or additionally, it can advantageously also be provided that the fastening portion, in place of a cutter part, is fitted into the receptacle, in particular in a form-fitting and/or latching manner, so as to secure the additional comminution tool on the foodstuff comminution device.

Particularly safe and reliable uncoupling of the additional comminution tool is achieved in an embodiment in which the fastening portion has a frame which is capable of being fitted into the receptacle of the main part and in which a press die of the activation part in the operating position engages, in particular in a form-fitting manner. In order for the operating position to be initiated in this embodiment, the fastening portion of the additional comminution tool, in place of a cutter part, is inserted into the receptacle while the activation part is situated in the placing position. The activation part is subsequently moved to the closing position. On account thereof, the fastening portion is jammed in a form-fitting manner between the main part and the activation part.

In order for the additional comminution tool to be released from the foodstuff comminution device again, the user in the case of this embodiment has only to pivot the activation part from the closing position back to the placing position such that the fastening portion configured in the shape of a frame can be retrieved from the receptacle again.

The foodstuff comminution device, in particular in such an embodiment, advantageously has a locking device by means of which the main part and the activation part in the closing position can be locked relative to one another. The locking device has the very particular advantage that the user does not have to permanently hold the main part and the activation part in the closing position by hand in order to ensure that the fastening portion remains jammed between the main part and the activation part. For example, the locking device can have an operating button by means of which switching can take place between a locking position and a releasing position. In this way, the user by means of the operating button can move the locking device to a locking position which has the effect that the main part and the activation part in the placing position are locked relative to one another, and the fastening portion cannot be unintentionally released.

Such a locking device very generally has the further advantage that the main part and the activation part in the closing position can be locked relative to one another, for example when the foodstuff comminution device is to be stored in a drawer. It is in this way avoided that the foodstuff comminution device unintentionally opens and is disruptively wedged within the drawer and/or with other apparatuses.

The additional comminution tool can advantageously be configured in particular as a mandolin slicer or as a grater. Alternatively, it can advantageously be provided that the additional comminution tool in the operating position, conjointly with at least one component of the foodstuff comminution device, forms a mandolin slicer or a grater.

In one very particularly advantageous embodiment, the additional comminution tool in the operating position, conjointly with at least one component of the foodstuff comminution device, forms a mandolin slicer or a grater, wherein it can particularly advantageously be provided that the foodstuff comminution device provides a sliding track, or at least one part of the sliding track of the mandolin slicer or of the grater, foodstuff material which is to be comminuted by means of the mandolin slicer or the grater being capable of being guided back and forth on said sliding track. For example, an external side of the activation part that in particular faces away from the main part can comprise the sliding track or a part of the sliding track.

In one advantageous embodiment the additional comminution tool has a further receptacle into which a cutter or grater insert is capable of being fitted, in particular in a non-destructive releasable and/or latching manner. The additional comminution tool in this embodiment functions as a mandolin slicer or as a grater, depending on the cutter or grater insert used. The foodstuff comminution system can in particular have a plurality of different cutter or grater inserts of which one can in each case be selectively fitted into the further receptacle. For example, a cutter or grater insert can have at least one, in particular precisely one, mandolin slicer blade. It is also possible that a cutter or grater insert has a plurality of Julienne blades or a plurality of grater projections, for example.

The foodstuff comminution device in a very particularly advantageous manner can have a coupling device for coupling to a container. In particular, a container, by means of the coupling device, can be capable of being coupled in such a manner that foodstuff material comminuted by means of the foodstuff comminution device is automatically caught by the container coupled thereto. Such an embodiment has the very particular advantage that the foodstuff material comminuted by means of the foodstuff comminution device, after the comminution procedure can be immediately transported in the container for storage or for further processing.

An embodiment in which the additional comminution tool has a further coupling device for coupling to a container is very particularly advantageous. The further coupling device is preferably configured in such a manner that a container can be coupled directly to the additional comminution tool such that foodstuff material comminuted by means of the additional comminution tool is automatically caught by the container coupled thereto. Such an embodiment has the very particular advantage that the foodstuff material comminuted by means of the additional comminution tool, after the comminution procedure can be immediately transported in the container for storage or for further processing.

In one very particularly advantageous embodiment, the coupling device and the further coupling device are of identical configuration. Such a foodstuff comminution system therefore has the very particular advantage that a container can be coupled selectively to the coupling device or to the further coupling device. In this way, the food comminution system can rely on a single container. In such an embodiment, the container is coupled either to the coupling device or to the further coupling device, depending on whether foodstuff material is currently being comminuted by means of the foodstuff comminution device or by means of the additional comminution tool However, a plurality of containers of which each can be selectively coupled to the coupling device or to the further coupling device are preferably present. To this end, the containers are of identical configuration at least in the coupling region. In particular, a plurality of containers having different capacities can be present, said containers however preferably being of identical configuration in the coupling region so as to be able to secure said containers selectively on the coupling device of the food comminution device or on the further coupling device of the additional comminution tool.

The foodstuff comminution device can advantageously be configured as a hand-held apparatus. Such an embodiment can be configured in a particularly compact manner and occupies little storage space when not in use. In particular, the foodstuff comminution device can advantageously be configured as a hand-held apparatus which, in a comminution procedure, is configured and specified for being held by hand or by hands, in particular without being set down on a worktop. To this end it can be advantageously provided in particular that the main part has a first handle part and the activation part has a second handle part, both handle parts being disposed so as to be capable of being collectively encompassed and mutually compressible, in particular in the manner of pliers, by the fingers of one hand.

The additional comminution tool can advantageously have a support foot by means of which the comminution tool, in a comminution procedure, in which a foodstuff material to be comminuted is guided by one hand back and forth across the sliding track, can be supported on a worktop, while the foodstuff comminution device situated in the closing position is simultaneously freely held by the other hand.

### BRIEF DESCRIPTION OF THE DRAWING VIEWS

The subject matter of the disclosure is illustrated in an exemplary and schematic manner in the drawing and will be described hereunder by means of the figures, wherein identical elements or elements of equivalent function are in most instances provided with the same reference signs even in different exemplary embodiments. In the figures:

FIGS. 1 to 6 show a first exemplary embodiment of a foodstuff comminution system according to the disclosure;

FIGS. 7 to 12 show a second exemplary embodiment of a foodstuff comminution system according to the disclosure;

FIGS. 13 to 17 show a third exemplary embodiment of a foodstuff comminution system according to the disclosure; and

FIGS. 18 to 22 show a fourth exemplary embodiment of a foodstuff comminution system according to the disclosure.

### DETAILED DESCRIPTION

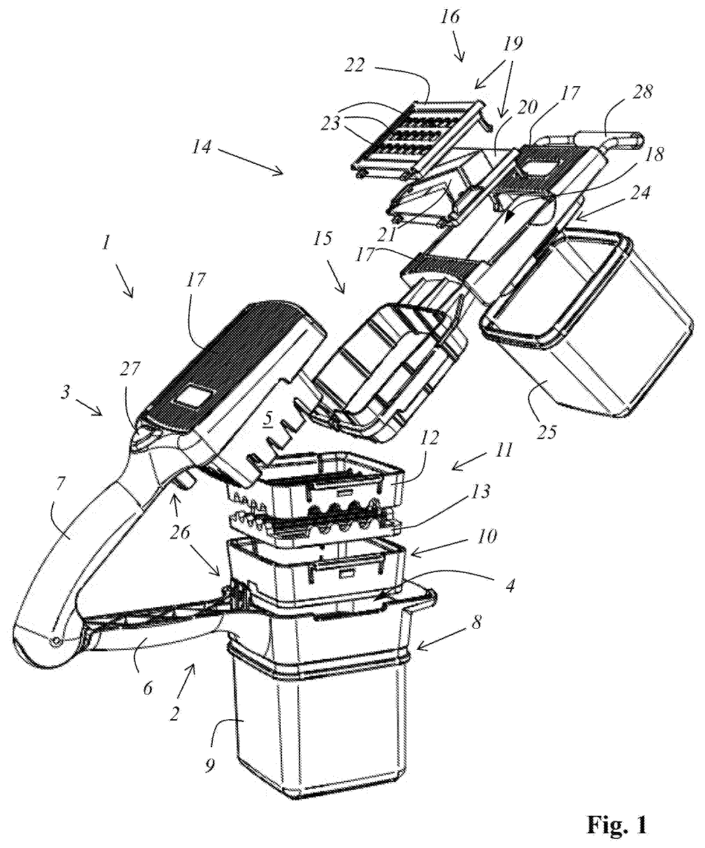

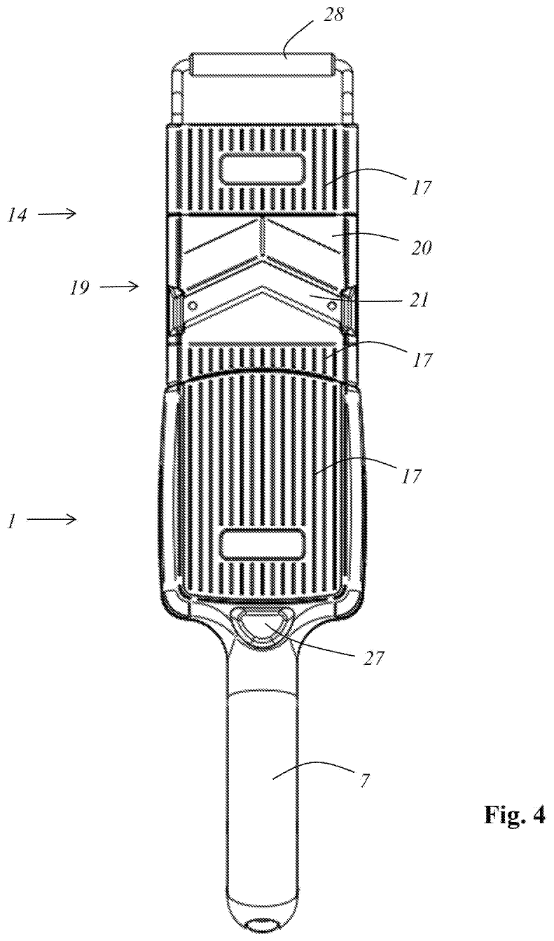

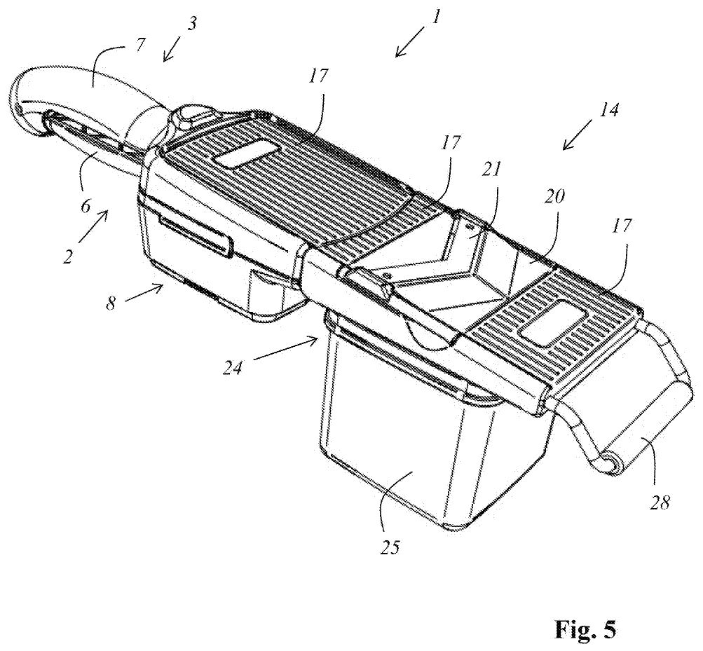

FIGS. 1 to 6 show a first exemplary embodiment of a foodstuff comminution system according to the disclosure, which has a foodstuff comminution device 1 having a main part 2 and an activation part 3.

The main part 2 has a receptacle 4 for a cutter part 10, 11. The activation part 3 has a press die 5 and is connected in an articulated manner to the main part 2. The activation part 3 for squeezing foodstuff material to be comminuted through the cutter part 10, 11 can be pivoted from a placing position towards the cutter part 10, 11 to a closing position and subsequently from the closing position back to the placing position.

The foodstuff comminution device 1 is configured as a hand-held apparatus such that said foodstuff comminution device 1, in a comminution procedure, in which the activation part 3 in the closing position is pushed against the main part 2, can be held by one or two hands.

The main part 2 has a first handle part 6, while the activation part 3 has a second handle part 7. The first handle part 6 and the second handle part 7, in a comminution procedure, can be conjointly encompassed by the fingers of one hand such that the first handle part 6 and the second handle part 7 can be mutually compressed in the manner of pliers.

The foodstuff comminution device 1 has a coupling device 8 for coupling to a container 9. The container 9, by means of the coupling device 8, can be coupled in such a manner that the comminuted foodstuff material squeezed through the cutter part 10, 11 is automatically caught by the container 9 coupled thereto. The container 9 can be retrieved in a non-destructive manner without tools, and can be coupled again, for example after an emptying procedure. To this end, the coupling device 8 has a latching device (not illustrated in more detail).

The foodstuff comminution device 1 can contain very different cutter inserts 10, 11.

In the exemplary embodiment illustrated, either a single cutter part 10 or a combination cutter part 11 can be selectively inserted into the receptacle 4. Alternatively or additionally, however, cutter inserts of other types may also be present.

The single cutter part 10 has cutting blades (not visible in this figure) which are supported by a holding frame and intersect in a centre point. A foodstuff material can be cut into wedge-shaped strips by way of the single cutter part 10.

Alternatively, a combination cutter part 11 which is composed of an upper part 12 and a lower part 13 can also be inserted into the receptacle 4. The combination cutter part 11 is distinguished in that the upper part 12 and the lower part 13 have in each case mutually parallel cutting blades. The cutting blades of the upper part 12 are aligned so as to be mutually parallel. The cutting blades of the lower part 13 are also aligned so as to be mutually parallel. The upper part 12 as well as the lower part 13 have in each case one holding frame which supports the cutting blades. The holding frames are provided with projections and concavities which permit the holding frames to be placed on top of one another in a form-fitting manner. It is prevented in this way that the holding frames are unintentionally mutually displaced.

The upper part 12 and the lower part 13 for cutting a foodstuff material into fine slices can be disposed on top of one another in the receptacle so as to have identically aligned cutting blades. Alternatively, it is also possible for the upper part 12 and the lower part 13 to be fitted into the receptacle so as to be mutually rotated by 90 degrees, thus so as to have a crossed arrangement of the cutting blades, in order for a foodstuff material to be able to cut into slivers which are square in the cross section.

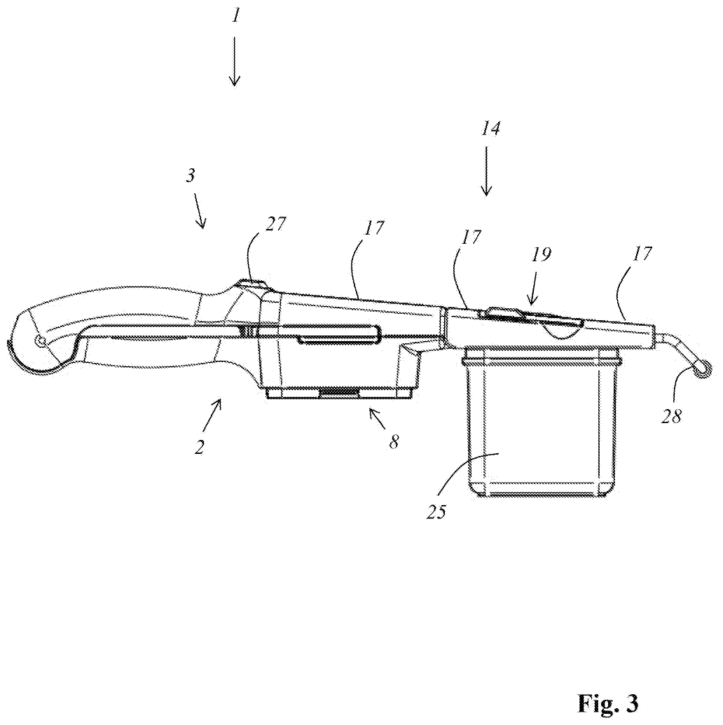

The foodstuff comminution system moreover has an additional comminution tool 14 which is capable of being secured in an operating position (illustrated in more detail in FIGS. 3, 4, and 5) on the foodstuff comminution device 1 and which has a fastening portion 15 as well as a tool portion 16.

In order for the operating position to be initiated, the fastening portion 15, in place of one of the cutter parts 10, 11, is inserted into the receptacle 4, and the activation part 3 is moved to the closing position. On account thereof, the fastening portion 15 is jammed in a form-fitting manner between the main part 2 and the activation part 3, wherein the tool portion 16 in the operating position is disposed outside the receptacle 4.

In order for the additional comminution tool 14 to be released from the foodstuff comminution device 1 again, the user has only to pivot the activation part 3 from the closing position back to the placing position such that the fastening portion 15 configured in the shape of a frame can be retrieved from the receptacle 4 again.

The foodstuff comminution device 1 has a locking device 26 by means of which the main part 2 and the activation part 3 in the closing position can be locked relative to one another. The locking device 26 has an operating button 27 by means of which switching can take place between a locking position and a releasing position. The locking device 26 has the very particular advantage that the user does not have to permanently hold the first handle part 6 and the second handle part 7 closed by hand in order to ensure that the fastening portion 15 remains jammed between the main part 2 and the activation part 3. The user by means of the operating button 27 can in fact move the locking device 26 to a locking position which has the effect that the main part 2 and the activation part 3 in the placing position are locked relative to one another, and the fastening portion 15 is not unintentionally released.

The fastening portion 15 (as opposed to the embodiment illustrated) could additionally also be configured as a cutter part and have cutting blades such that the foodstuff comminution device 1 could also be operated with the fastening portion 15 functioning as a further cutter part.

The additional comminution tool 14 in the operating position (illustrated in particular in FIGS. 3 to 5), conjointly with a component of the foodstuff comminution device 1, forms a mandolin slicer or a grater. The foodstuff comminution device 1 provides a part of a sliding track 17 of the mandolin slicer or of the grater. A further part of the sliding track 17 is a component part of the tool portion 16.

The additional comminution tool 14 in the region of the tool portion 16 has a further receptacle 18 into which a cutter or grater insert is capable of being fitted, in particular in a non-destructive releasable and/or latching manner. The cutter or grater insert 19 can be configured as a mandolin slicer insert 20 which has a mandolin slicer blade 21, for example. The cutter or grater insert 19 can also be configured as a Julienne insert 22 which has a plurality of Julienne blades 23, for example. The cutter or grater insert can also have a multiplicity of grater projections, for example.

In the operating position, a foodstuff material to be comminuted can be moved back and forth along the sliding track 17 such that the foodstuff material to be comminuted is repeatedly guided across the cutter or grater insert 19 and is thus successively comminuted.

The additional comminution tool 14 has a further coupling device 24 for coupling to a further container 25. The further container 25, by means of the further coupling device 24, can be coupled in such a manner that foodstuff material comminuted by means of the additional comminution tool 14 is automatically caught by the further container 25 coupled thereto. The further coupling device 24 is preferably configured in such a manner that the further container 25 can be coupled and uncoupled without tools and in each case in a non-destructive manner. A latching device is preferably present to this end.

The coupling device 8 and the further coupling device 24 are of identical configuration. The container 9 and the further container 25 are likewise of identical configuration. The foodstuff comminution system illustrated therefore has the very particular advantage that the container 9 can selectively also be coupled to the further coupling device 24, and/or that the further container 25 can selectively also be coupled to the coupling device 8. It is also possible for a total of only one container 9, 25 to be used, wherein said container 9, 25 is coupled either to the coupling device 8 or to the further coupling device 24, depending on whether foodstuff material is currently being comminuted by means of the foodstuff comminution device 1 or by means of the additional comminution tool 14.

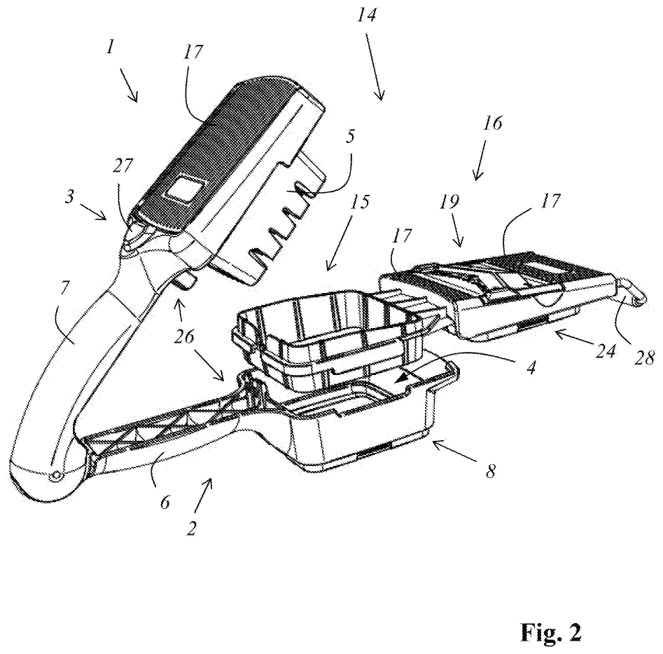

FIG. 2 shows parts of the foodstuff comminution system according to the disclosure in the procedure of initiating the operating position. No cutter part 10, 11 is inserted in the receptacle 4 of the foodstuff comminution device 1. Instead, the fastening portion 15 of the additional comminution tool 14 is fitted into the receptacle 4 in order for the operating position to be initiated, while the activation part 3 is situated in the placing position. The activation part 3 is subsequently moved to the closing position such that the fastening portion 15 configured in the shape of a frame is held in a form-fitting manner between the wall of the receptacle 4 and the press die 5 of the activation part 3, this being illustrated in FIGS. 3 to 5.

FIGS. 3 to 5 show the foodstuff comminution device 1 having the additional comminution tool 14 coupled thereto in a lateral view, in a view from above, and in a perspective illustration. It can be clearly seen that the activation part 3 by way of the upper side thereof provides a part of the sliding track 17, a foodstuff material to be comminuted being able to be guided back and forth along said sliding track 17.

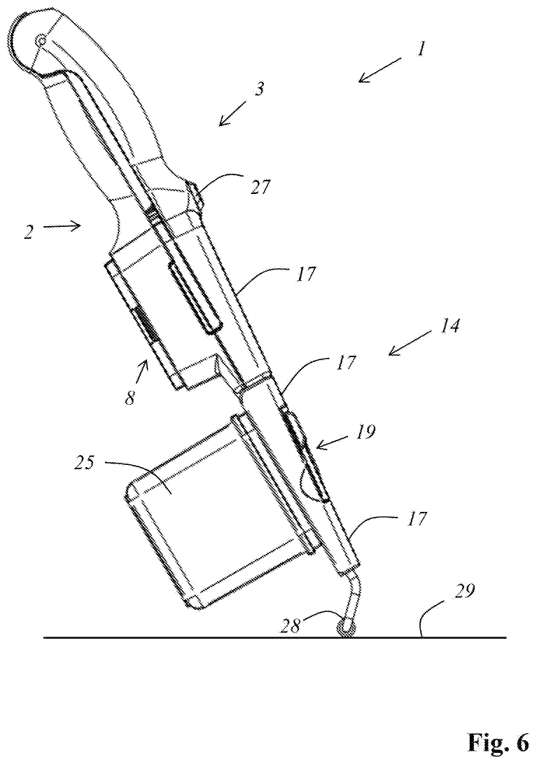

The additional comminution tool 14 at the end thereof that faces away from the fastening portion 15 has a support foot 28 which is configured so as to be U-shaped and which, in a comminution procedure, in which a foodstuff material to be comminuted is guided by one hand back and forth across the sliding track 17, can be placed on a worktop 29, for example a tabletop, while the foodstuff comminution device 1 which is situated in the closing position is simultaneously freely held by the other hand, this being illustrated in FIG. 6.

The additional comminution tool 14 is capable of being secured in a non-destructive releasable manner in an operating position on the foodstuff comminution device 1, wherein the tool portion 16 in the operating position is disposed outside the receptacle 4 and outside the pivoting range of the activation part 3 which is connected in an articulated manner to the main part 2.

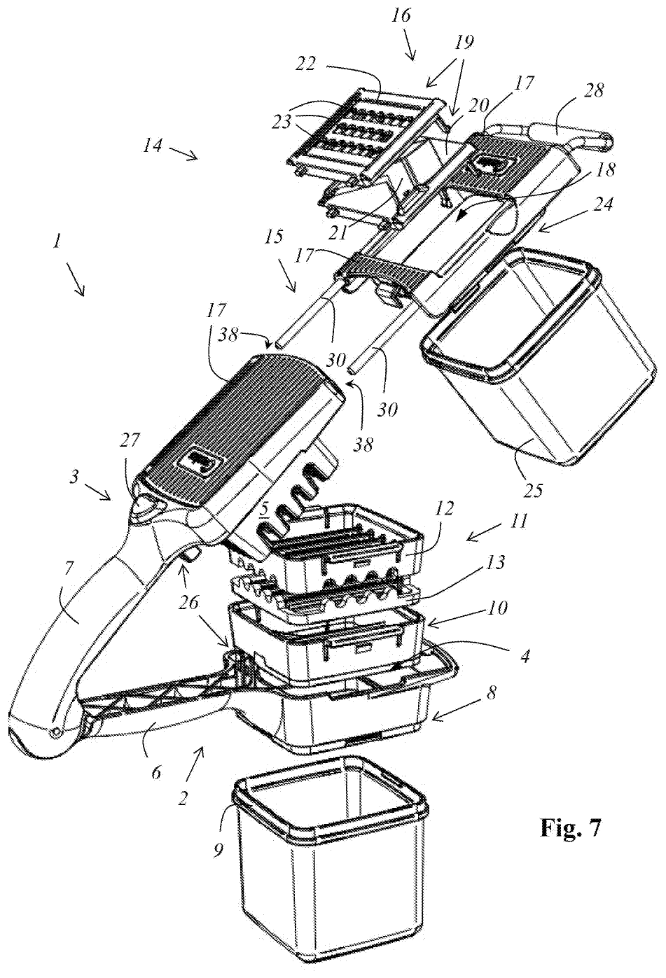

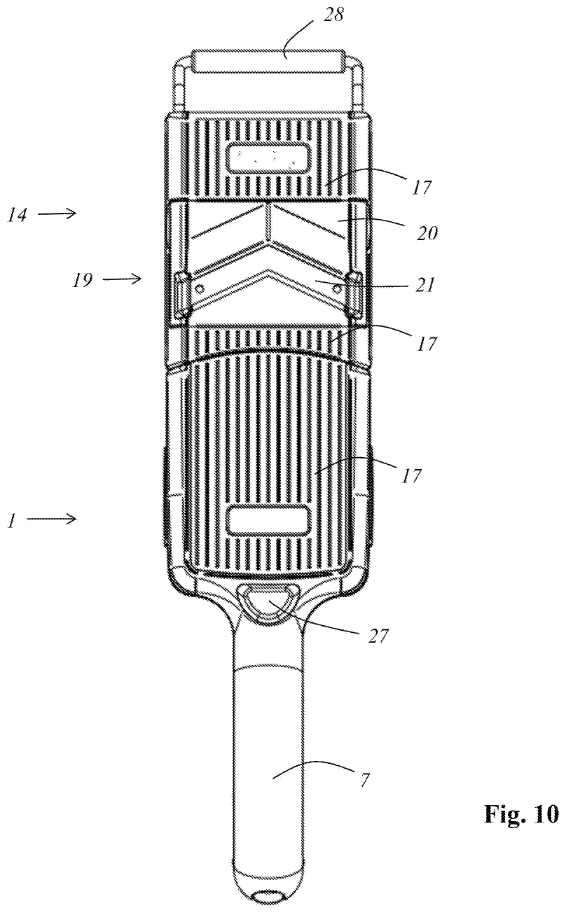

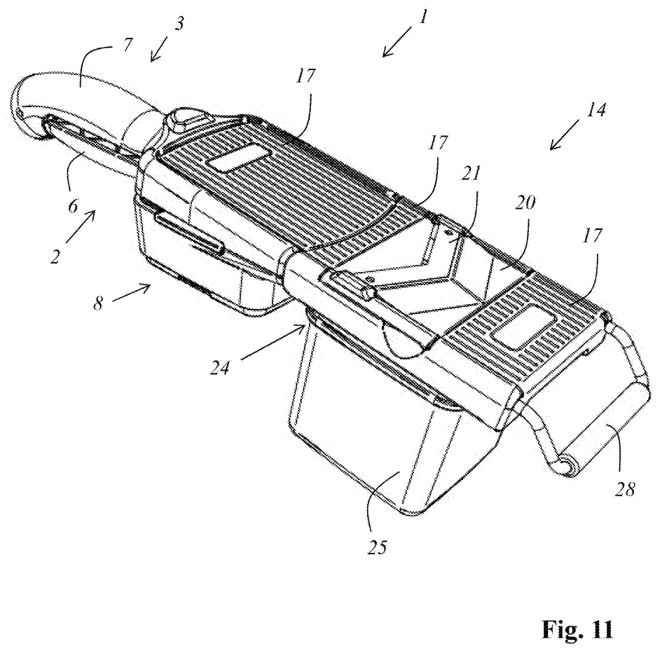

FIGS. 7 to 12 show a second exemplary embodiment of a foodstuff comminution system according to the disclosure, which has a foodstuff comminution device 1 having a main part 2 and an activation part 3.

The main part 2 has a receptacle 4 for a cutter part 10, 11. The activation part 3 has a press die 5 and is connected in an articulated manner to the main part 2. The activation part 3 for squeezing foodstuff material to be comminuted through the cutter part 10, 11 can be pivoted from a placing position towards the cutter part 10, 11 to a closing position and subsequently from the closing position back to the placing position.

The foodstuff comminution device 1 is configured as a hand-held apparatus such that said foodstuff comminution device 1, in a comminution procedure, in which the activation part 3 in the closing position is pushed against the main part 2, can be held by one or two hands.

The main part 2 has a first handle part 6, while the activation part 3 has a second handle part 7. The first handle part 6 and the second handle part 7, in a comminution procedure, can be conjointly encompassed by the fingers of one hand such that the first handle part 6 and the second handle part 7 can be mutually compressed in the manner of pliers.

The foodstuff comminution device 1 has a coupling device 8 for coupling to a container 9. The container 9, by means of the coupling device 8, can be coupled in such a manner that the comminuted foodstuff material squeezed through the cutter part 10, 11 is automatically caught by the container 9 coupled to said container 9. The container 9 can be retrieved in a non-destructive manner without tools, and can be coupled again, for example after an emptying procedure. To this end, the coupling device 8 has a latching device (not illustrated in more detail).

The foodstuff comminution device 1 can contain very different cutter inserts 10, 11.

In the exemplary embodiment illustrated, either a single cutter part 10 or a combination cutter part 11 can be selectively inserted into the receptacle 4. Alternatively or additionally, however, cutter inserts of other types may also be present.

The single cutter part 10 has cutting blades (not visible in this figure) which are supported by a holding frame and intersect in a centre point. A foodstuff material can be cut into wedge-shaped strips by way of the single cutter part 10.

Alternatively, a combination cutter part 11 which is composed of an upper part 12 and a lower part 13 can also be inserted into the receptacle 4. The combination cutter part 11 is distinguished in that the upper part 12 and the lower part 13 have in each case mutually parallel cutting blades. The cutting blades of the upper part 12 are aligned so as to be mutually parallel. The cutting blades of the lower part 13 are also aligned so as to be mutually parallel. The upper part 12 as well as the lower part 13 have in each case one holding frame which supports the cutting blades. The holding frames are provided with projections and concavities which permit the holding frames to be placed on top of one another in a form-fitting manner. It is prevented in this way that the holding frames are unintentionally mutually displaced.

The upper part 12 and the lower part 13 for cutting a foodstuff material into fine slices can be disposed on top of one another in the receptacle so as to have identically aligned cutting blades. Alternatively, it is also possible for the upper part 12 and the lower part 13 to be fitted into the receptacle so as to be mutually rotated by 90 degrees, thus so as to have a crossed arrangement of the cutting blades, in order for a foodstuff material to be able to cut into slivers which are square in the cross section.

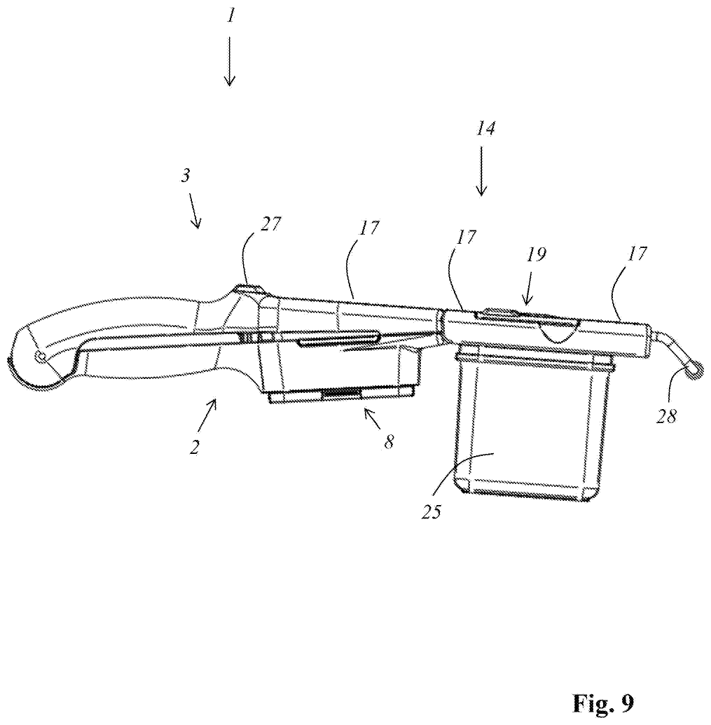

The foodstuff comminution system moreover has an additional comminution tool 14 which is capable of being secured in an operating position (illustrated in more detail in FIGS. 9, 10, 11, and 12) on the foodstuff comminution device 1 and which has a fastening portion 15 as well as a tool portion 16.

The fastening portion 15 contains two elongate carriers 30.

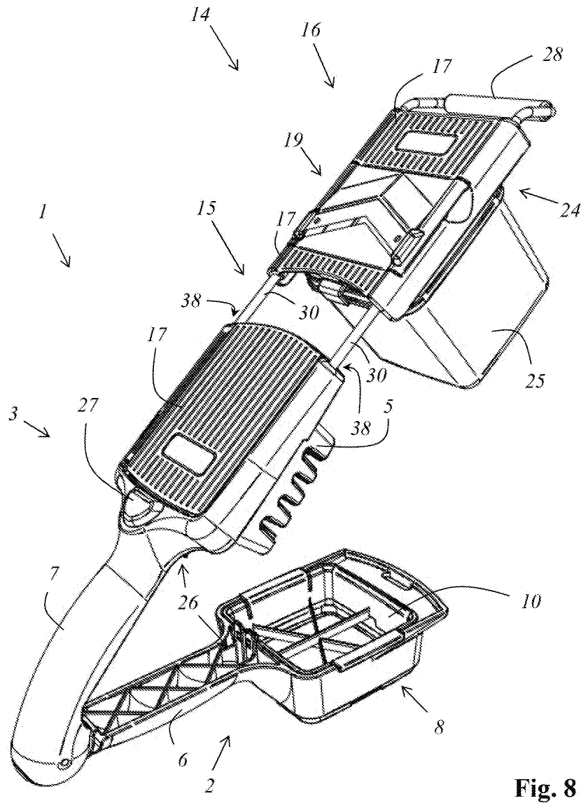

The activation part 3 has a mating fastening means 31 which is configured and specified for interacting with the fastening portion 15 of the additional comminution tool 14 so as to secure the additional comminution tool 14 in the operating position on the activation part 3. The mating fastening means 31 is composed of two elongate recesses 38 into which the carriers 30 can be pushed in a form-fitting manner for initiating the operating position. FIG. 8 shows parts of the foodstuff comminution system according to the disclosure in the procedure of initiating the operating position.

In order for the additional comminution tool 14 to be released from the foodstuff comminution device 1 again, the user has only to extract the carriers 30 from the recesses 38 again.

The foodstuff comminution device 1 has a locking device 26 by means of which the main part 2 and the activation part 3 in the closing position can be locked relative to one another. The locking device 26 has an operating button 27 by means of which switching can take place between a locking position and a releasing position. The locking device 26 has the very particular advantage that the main part 2 and the activation part 3 in the closing position can be locked relative to one another, when the foodstuff comminution device 1 is to be stored in a drawer. It is avoided in this way that the foodstuff comminution device 1 unintentionally opens.

The additional comminution tool 14 in the operating position (illustrated in particular in FIGS. 9 to 12), conjointly with a component of the foodstuff comminution device 1, forms a mandolin slicer or a grater. The foodstuff comminution device 1 provides a part of a sliding track 17 of the mandolin slicer or of the grater. A further part of the sliding track 17 is a component part of the tool portion 16.

The additional comminution tool 14 in the region of the tool portion 16 has a further receptacle 18 into which a cutter or grater insert is capable of being fitted, in particular in a non-destructively releasable and/or latching manner. The cutter or grater insert 19 can be configured as a mandolin slicer insert 20 which has a mandolin slicer blade 21, for example. The cutter or grater insert 19 can also be configured as a Julienne insert 22 which has a plurality of Julienne blades 23, for example. The cutter or grater insert can also have a multiplicity of grater projections, for example.

In the operating position, a foodstuff material to be comminuted can be moved back and forth along the sliding track 17 such that the foodstuff material to be comminuted is repeatedly guided across the cutter or grater insert 19 and is thus successively comminuted.

The additional comminution tool 14 has a further coupling device 24 for coupling to a further container 25. The further container 25, by means of the further coupling device 24, can be coupled in such a manner that foodstuff material comminuted by means of the additional comminution tool 14 is automatically caught by the further container 25 coupled thereto. The further coupling device 24 is preferably configured in such a manner that the further container 25 can be coupled and uncoupled without tools and in each case in a non-destructive manner. A latching device is preferably present to this end.

The coupling device 8 and the further coupling device 24 are of identical configuration. The container 9 and the further container 25 are likewise of identical configuration. The foodstuff comminution system illustrated therefore has the very particular advantage that the container 9 can selectively also be coupled to the further coupling device 24, and/or that the further container 25 can selectively also be coupled to the coupling device 8. It is also possible for a total of only one container 9, 25 to be used, wherein said container 9, 25 is coupled either to the coupling device 8 or to the further coupling device 24, depending on whether foodstuff material is currently being comminuted by means of the foodstuff comminution device 1 or by means of the additional comminution tool 14.

FIGS. 9 to 11 show the foodstuff comminution device 1 having the additional comminution tool 14 coupled thereto in a lateral view, in a view from above, and in a perspective illustration. It can be clearly seen that the activation part 3 by way of the upper side thereof provides a part of the sliding track 17, a foodstuff material to be comminuted being able to be guided back and forth along said sliding track 17.

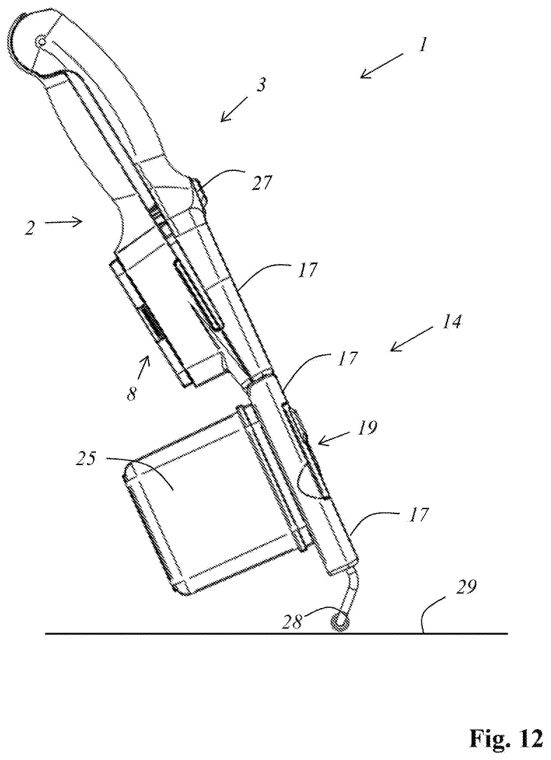

The additional comminution tool 14 at the end thereof that faces away from the fastening portion 15 has a support foot 28 which is configured so as to be U-shaped and by way of which the foodstuff comminution system, in a comminution procedure, in which a foodstuff material to be comminuted is guided by one hand back and forth across the sliding track 17, can be supported on a worktop 29, for example a tabletop, while the foodstuff comminution device 1 which is situated in the closing position is simultaneously freely held by the other hand, this being illustrated in FIG. 12.

The additional comminution tool 14 is capable of being secured in a non-destructive releasable manner in an operating position on the foodstuff comminution device 1, wherein the tool portion 16 in the operating position is disposed outside the receptacle 4 and outside the pivoting range of the activation part 3 which is connected in an articulated manner to the main part 2.

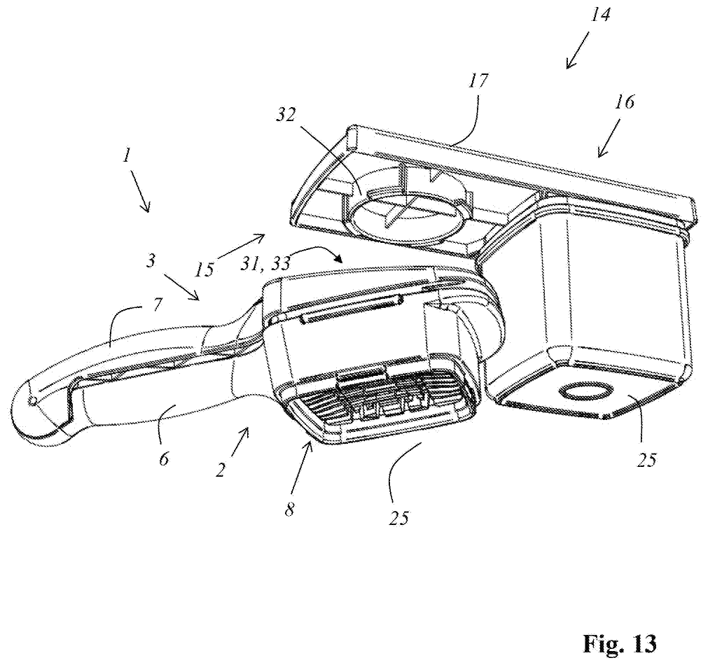

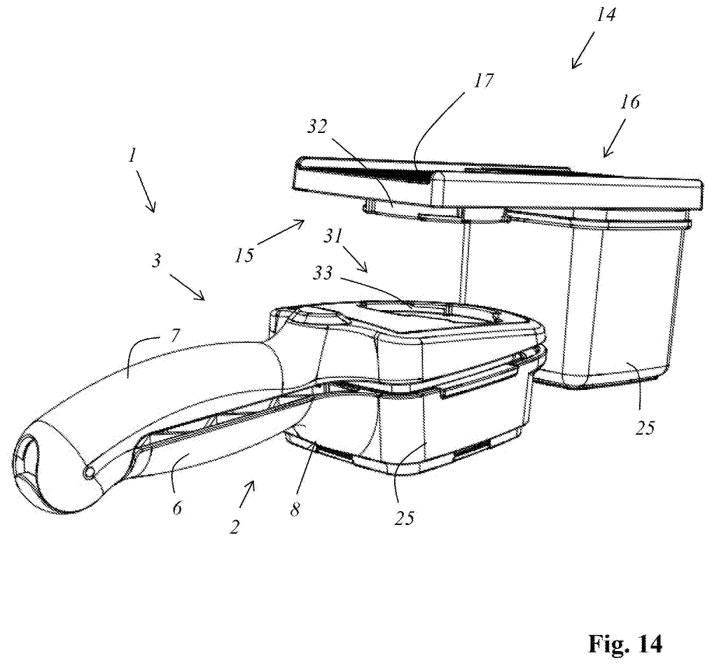

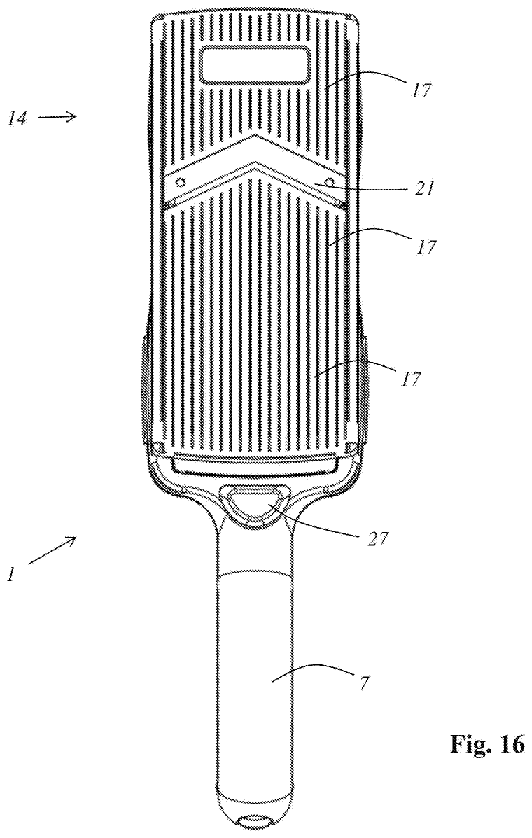

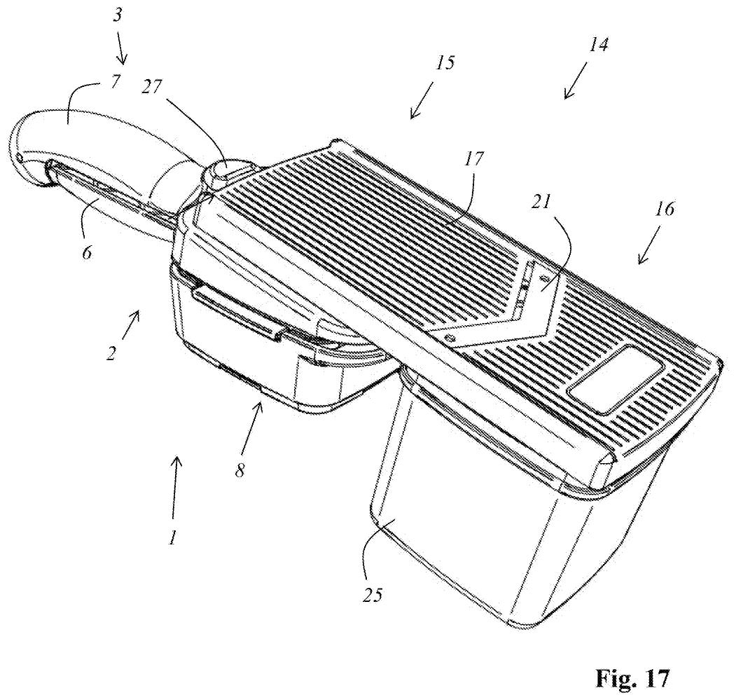

FIGS. 13 to 17 show a third exemplary embodiment of a foodstuff comminution system according to the disclosure, which has a foodstuff comminution device 1 having a main part 2 and an activation part 3.

The main part 2 has a receptacle 4 for a cutter part 10, 11 (not visible in FIGS. 13 to 17). The activation part 3 has a press die 5 and is connected in an articulated manner to the main part 2. The activation part 3 for squeezing foodstuff material to be comminuted through the cutter part 10, 11 can be pivoted from a placing position towards the cutter part 10, 11 to a closing position and subsequently from the closing position back to the placing position.

The foodstuff comminution device 1 is configured as a hand-held apparatus such that said foodstuff comminution device 1, in a comminution procedure, in which the activation part 3 in the closing position is pushed against the main part 2, can be held by one or two hands.

The main part 2 has a first handle part 6, while the activation part 3 has a second handle part 7. The first handle part 6 and the second handle part 7, in a comminution procedure, can be conjointly encompassed by the fingers of one hand such that the first handle part 6 and the second handle part 7 can be mutually compressed in the manner of pliers.

The foodstuff comminution device 1 has a coupling device 8 for coupling to a container 9 (not visible in FIGS. 13 to 17). The container 9, by means of the coupling device 8, can be coupled in such a manner that the comminuted foodstuff material squeezed through the cutter part 10, 11 is automatically caught by the container 9 coupled thereto. The container 9 can be retrieved in a non-destructive manner without tools, and can be coupled again, for example after an emptying procedure. To this end, the coupling device 8 has a latching device (not illustrated in more detail).

The foodstuff comminution device 1 can contain very different cutter inserts 10, 11.

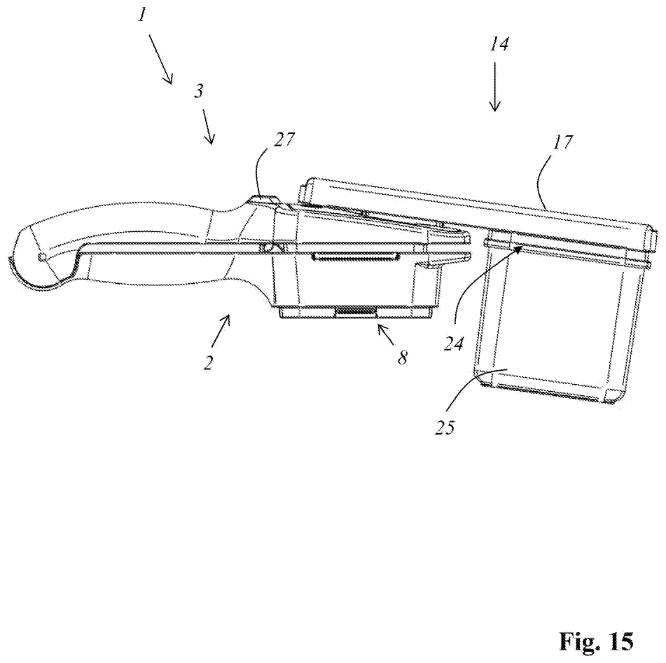

The foodstuff comminution system moreover has an additional comminution tool 14 which is capable of being secured in an operating position (illustrated in more detail in FIGS. 15, 16, and 17) on the foodstuff comminution device 1 and which has a fastening portion 15 as well as a tool portion 16.

The additional comminution tool 14 is capable of being secured in a non-destructive releasable manner in an operating position on the foodstuff comminution device 1, wherein the tool portion 16 in the operating position is disposed outside the receptacle 4 and outside the pivoting range of the activation part 3 which is connected in an articulated manner to the main part 2.

The activation part 3 has a mating fastening means 31 which is configured and specified for interacting with the fastening portion 15 of the additional comminution tool 14 so as to secure the additional comminution tool 14 in the operating position on the activation part 3. The fastening portion 15 and the mating fastening means 31 form a bayonet connection.

In order for the operating position to be initiated, a bayonet projection 32 of the fastening portion 15 is introduced into a bayonet receptacle 33 of the mating fastening means 31, and a rotation by approx. 30 degrees is subsequently carried out, on account of which a fixed connection is established.

In order for the additional comminution tool 14 to be released from the foodstuff comminution device 1 again, the user has to rotate the additional comminution tool 14 relative to the foodstuff comminution device 1 by approx. 30 degrees again, and can then retrieve the bayonet projection 32 of the fastening portion 15 from the bayonet receptacle 33 of the mating fastening means 31 again.

The foodstuff comminution device 1 has a locking device 26 by means of which the main part 2 and the activation part 3 in the closing position can be locked relative to one another. The locking device 26 has an operating button 27 by means of which switching can take place between a locking position and a releasing position. The locking device 26 has the very particular advantage that the main part 2 and the activation part 3 in the closing position can be locked relative to one another, when the foodstuff comminution device 1 is to be stored in a drawer. It is avoided in this way that the foodstuff comminution device 1 unintentionally opens.

The additional comminution tool 14 is configured as a mandolin slicer having a sliding track 17 and a mandolin slicer blade 21.

In the operating position, a foodstuff material to be comminuted can be moved back and forth along the sliding track 17 such that the foodstuff material to be comminuted is repeatedly guided across the cutter or grater insert 19 and is thus successively comminuted.

The additional comminution tool 14 has a further coupling device 24 for coupling to a further container 25. The further container 25, by means of the further coupling device 24, can be coupled in such a manner that foodstuff material comminuted by means of the additional comminution tool 14 is automatically caught by the further container 25 coupled thereto. The further coupling device 24 is preferably configured in such a manner that the further container 25 can be coupled and uncoupled without tools and in each case in a non-destructive manner. A latching device is preferably present to this end.

The coupling device 8 and the further coupling device 24 are of identical configuration. The container 9 and the further container 25 are likewise of identical configuration. The foodstuff comminution system illustrated therefore has the very particular advantage that the container 9 can selectively also be coupled to the further coupling device 24, and/or that the further container 25 can selectively also be coupled to the coupling device 8. It is also possible for a total of only one container 9, 25 to be used, wherein said container 9, 25 is coupled either to the coupling device 8 or to the further coupling device 24, depending on whether foodstuff material is currently being comminuted by means of the foodstuff comminution device 1 or by means of the additional comminution tool 14.

FIGS. 15 to 17 show the foodstuff comminution device 1 having the additional comminution tool 14 coupled thereto in a lateral view, in a view from above, and in a perspective illustration.

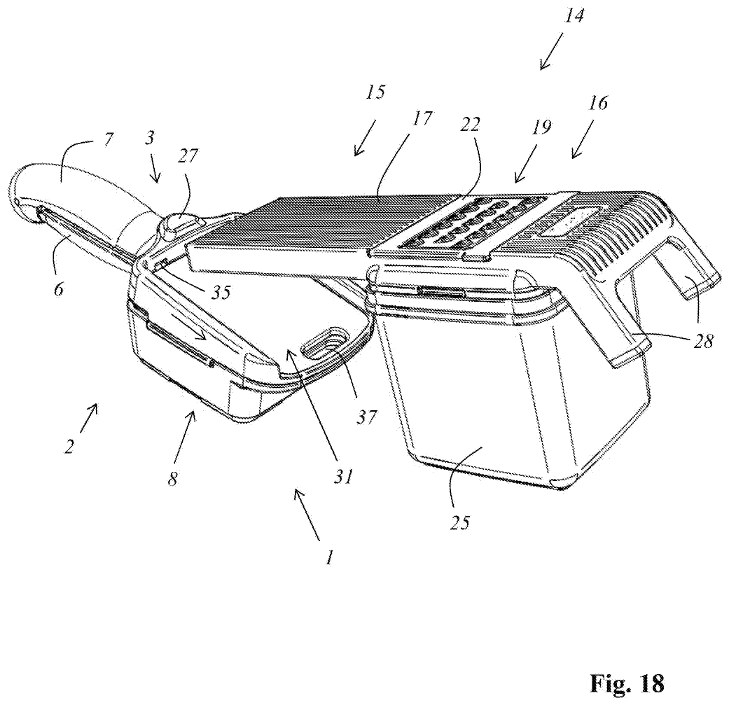

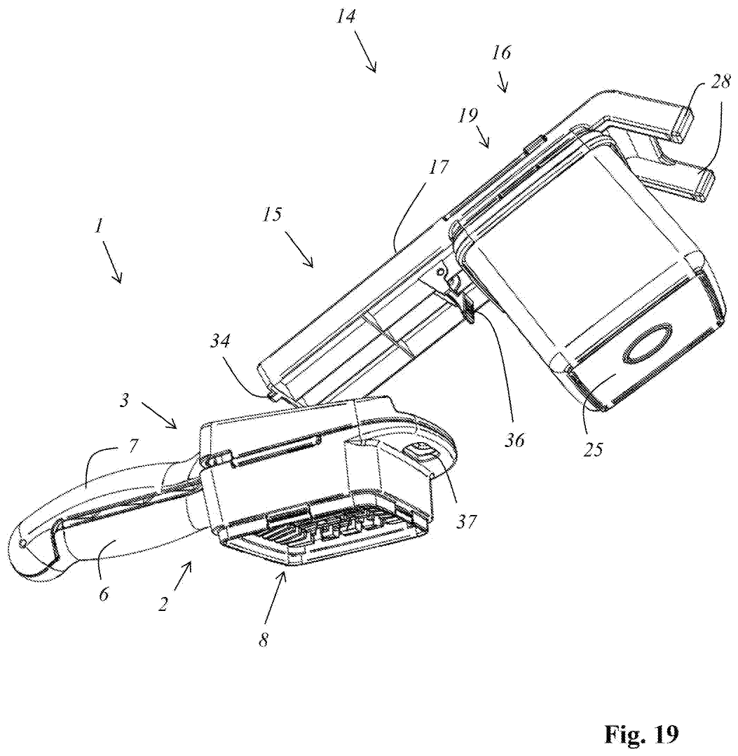

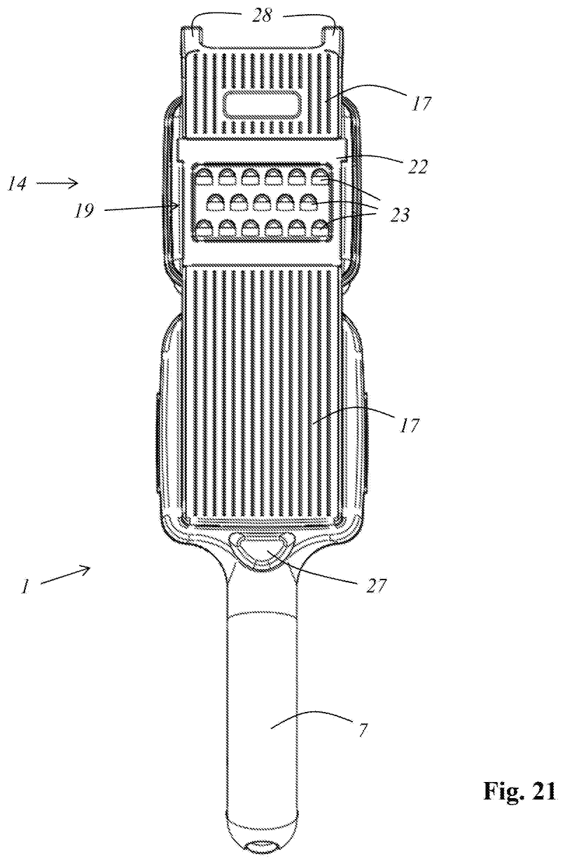

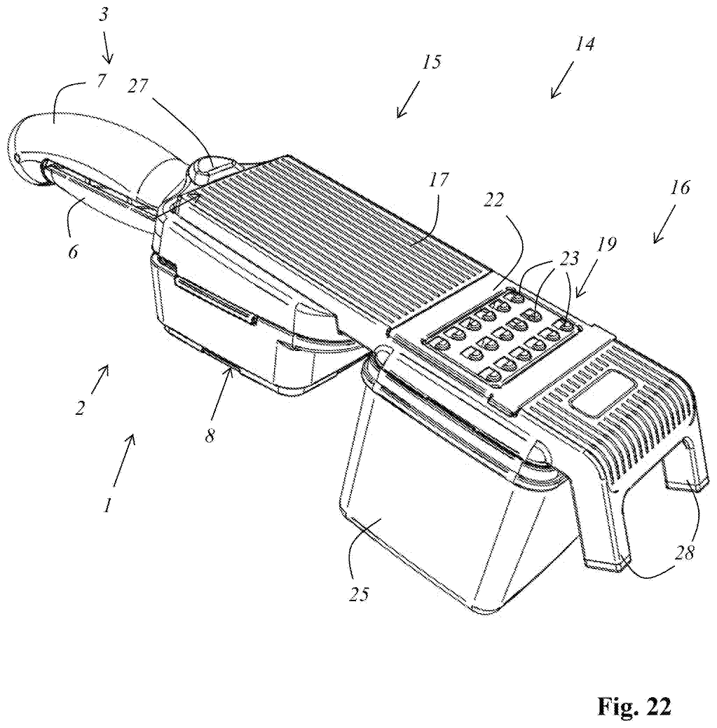

FIGS. 18 to 22 show a fourth exemplary embodiment of a foodstuff comminution system according to the disclosure, which has a foodstuff comminution device 1 having a main part 2 and an activation part 3.

The main part 2 has a receptacle 4 for a cutter part 10, 11 (not visible in FIGS. 18 to 22). The activation part 3 has a press die 5 and is connected in an articulated manner to the main part 2. The activation part 3 for squeezing foodstuff material to be comminuted through the cutter part 10, 11 can be pivoted from a placing position towards the cutter part 10, 11 to a closing position and subsequently from the closing position back to the placing position.

The foodstuff comminution device 1 is configured as a hand-held apparatus such that said foodstuff comminution device 1, in a comminution procedure, in which the activation part 3 in the closing position is pushed against the main part 2, can be held by one or two hands.

The main part 2 has a first handle part 6, while the activation part 3 has a second handle part 7. The first handle part 6 and the second handle part 7, in a comminution procedure, can be conjointly encompassed by the fingers of one hand such that the first handle part 6 and the second handle part 7 can be mutually compressed in the manner of pliers.

The foodstuff comminution device 1 has a coupling device 8 for coupling to a container 9 (not illustrated in FIGS. 18 to 22). The container 9, by means of the coupling device 8, can be coupled in such a manner that the comminuted foodstuff material squeezed through the cutter part 10, 11 is automatically caught by the container 9 coupled thereto. The container 9 can be retrieved in a non-destructive manner without tools, and can be coupled again, for example after an emptying procedure. To this end, the coupling device 8 has a latching device (not illustrated in more detail).

The foodstuff comminution device 1 can contain very different cutter inserts 10, 11.

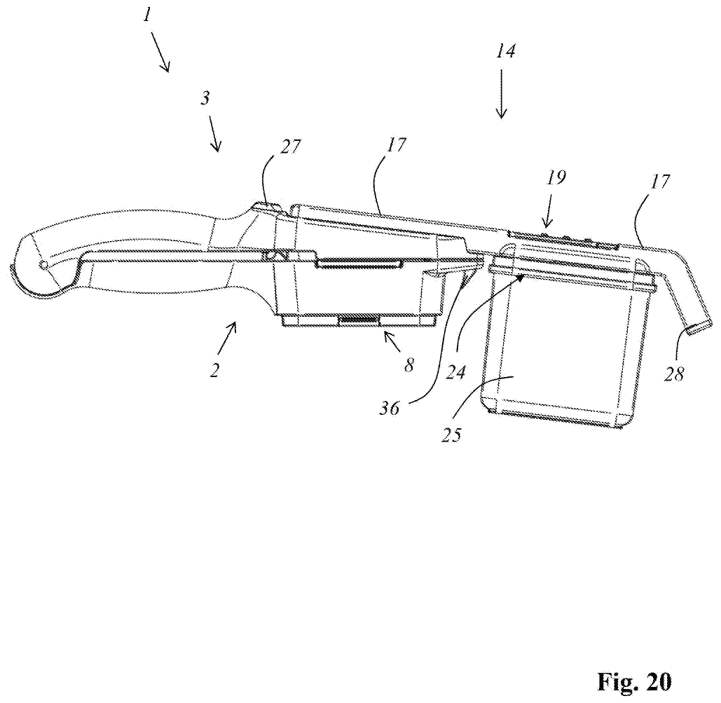

The foodstuff comminution system moreover has an additional comminution tool 14 which is capable of being secured in an operating position (illustrated in more detail in FIGS. 20, 21, and 22) on the foodstuff comminution device 1 and which has a fastening portion 15 as well as a tool portion 16.

The additional comminution tool 14 is capable of being secured in a non-destructive releasable manner in an operating position on the foodstuff comminution device 1, wherein the tool portion 16 in the operating position is disposed outside the receptacle 4 and outside the pivoting range of the activation part 3 which is connected in an articulated manner to the main part 2.

The activation part 3 has a mating fastening means 31 which is configured and specified for interacting with the fastening portion 15 of the additional comminution tool 14 so as to secure the additional comminution tool 14 in the operating position on the activation part 3. The fastening portion 15 and the mating fastening means 31 in this exemplary embodiment form a latching connection. To this end, the fastening portion 15 has two projections 34 which, emanating obliquely from above, can be plugged into recesses 35 of the mating fastening means 31. The additional comminution tool 14 is subsequently pivoted about the end, which comprises the plugged-in projections 34, towards the mating fastening means 31, such that a latching cam 36 comes to engage with a latching opening 37, on account of which a fixed connection is established.

In order for the additional comminution tool 14 to be released from the foodstuff comminution device 1 again, the user has to release the latching cam 36 from the latching opening 37, and can then retrieve the additional comminution tool 14 from the foodstuff comminution device 1 again.

The foodstuff comminution device 1 has a locking device 26 by means of which the main part 2 and the activation part 3 in the closing position can be locked relative to one another. The locking device 26 has an operating button 27 by means of which switching can take place between a locking position and a releasing position. The locking device 26 has the very particular advantage that the main part 2 and the activation part 3 in the closing position can be locked relative to one another, when the foodstuff comminution device 1 is to be stored in a drawer. It is avoided in this way that the foodstuff comminution device 1 unintentionally opens.

The additional comminution tool 14, depending on the cutter or grater insert 19 used, is configured as a mandolin slicer or a grater having a sliding track 17.

The additional comminution tool 14 in the region of the tool portion 16 has a further receptacle 18 into which a cutter or grater insert is capable of being fitted, in particular in a non-destructive releasable and/or latching manner. The cutter or grater insert 19 can be configured as a mandolin slicer insert 20 which has a mandolin slicer blade 21, for example. The cutter or grater insert 19 can also be configured as a Julienne insert 22 which has a plurality of Julienne blades 23, for example. The cutter or grater insert can also have a multiplicity of grater projections, for example.

In the operating position, a foodstuff material to be comminuted can be moved back and forth along the sliding track 17 such that the foodstuff material to be comminuted is repeatedly guided across the cutter or grater insert 19 and is thus successively comminuted.

The additional comminution tool 14 has a further coupling device 24 for coupling to a further container 25. The further container 25, by means of the further coupling device 24, can be coupled in such a manner that foodstuff material comminuted by means of the additional comminution tool 14 is automatically caught by the further container 25 coupled thereto. The further coupling device 24 is preferably configured in such a manner that the further container 25 can be coupled and uncoupled without tools and in each case in a non-destructive manner. A latching device is preferably present to this end.

The coupling device 8 and the further coupling device 24 are of identical configuration. The container 9 and the further container 25 are likewise of identical configuration. The foodstuff comminution system illustrated therefore has the very particular advantage that the container 9 can selectively also be coupled to the further coupling device 24, and/or that the further container 25 can selectively also be coupled to the coupling device 8. It is also possible for a total of only one container 9, 25 to be used, wherein said container 9, 25 is coupled either to the coupling device 8 or to the further coupling device 24, depending on whether foodstuff material is currently being comminuted by means of the foodstuff comminution device 1 or by means of the additional comminution tool 14.

FIGS. 20 to 22 show the foodstuff comminution device 1 having the additional comminution tool 14 coupled thereto in a lateral view, in a view from above, and in a perspective illustration.

The additional comminution tool 14 at the end thereof that faces away from the fastening portion 15 has two support feet 28 by way of which the foodstuff comminution system, in a comminution procedure, in which a foodstuff material to be comminuted is guided by one hand back and forth across the sliding track 17, can be supported on a worktop 29, for example a tabletop, while the foodstuff comminution device 1 which is situated in the closing position is simultaneously freely held by the other hand.

### LIST OF REFERENCE SIGNS

1 Foodstuff comminution device
2 Main part
3 Activation part
4 Receptacle
5 Press die
6 First handle part
7 Second handle part
8 Coupling device
9 Container
10 Single cutter part
11 Combination cutter part
12 Upper part of the combination cutter part 11
13 Lower part of the combination cutter part 11
14 Additional comminution tool
15 Fastening portion
16 Tool portion
17 Sliding track
18 Further receptacle
19 Cutter or grater insert
20 Mandolin slicer insert
21 Mandolin slicer blade
22 Julienne insert
23 Julienne blade
24 Further coupling device
25 Further container
26 Locking device
27 Operating button
28 Support foot
29 Worktop
30 Carrier
31 Mating fastening means
32 Bayonet projection
33 Bayonet receptacle
34 Projection
35 Recess
36 Latching cam
37 Latching opening
38 Elongate recess

1. A foodstuff comminution system comprising:
a foodstuff comminution device having a main part which has a receptacle for a cutter part, and having an activation part connected to the main part for squeezing foodstuff material to be comminuted through a cutter part inserted in the receptacle, wherein the activation part is pivotable towards the cutter part from a placing position to a closing position and subsequently from the closing position back to the placing position, and
an additional comminution tool securable in an operating position on the foodstuff comminution device, wherein the additional comminution tool in the operating position, conjointly with at least one component of the foodstuff comminution device, forms a mandolin slicer or a grater, wherein foodstuff material which is to be comminuted by means of the mandolin slicer or the grater is guided back and forth on a sliding track, and
wherein the foodstuff comminution device provides the sliding track, or at least a part of the sliding track.

2. The foodstuff comminution system according to claim 1, wherein the additional comminution tool is securable in the operating position on the foodstuff comminution device in a non-destructive releasable manner.

3. The foodstuff comminution system according to claim 1, wherein the additional comminution tool has a fastening portion and a tool portion, wherein the tool portion in the operating position is disposed outside the receptacle and/or outside a pivoting range of the activation part.

4. The foodstuff comminution system according to claim 3, wherein the activation part or the main part has a mating fastening means for interacting with the fastening portion of the additional comminution tool to secure the additional comminution tool in the operating position on the activation part or on the main part.

5. The foodstuff comminution system according to claim 4, wherein the fastening portion and the mating fastening means form a bayonet connection.

6. The foodstuff comminution system according to claim 4, wherein the mating fastening means is disposed on an external side of the activation part that faces away from the main part.

7. The foodstuff comminution system according to claim 6, wherein the mating fastening means has at least one recess, and the fastening portion has at least one carrier for being introduced in a form-fitting manner into the recess to secure the additional comminution tool in the operating position.

8. The foodstuff comminution system according to claim 7, wherein the fastening portion in the operating position is jammed in a form-fitting manner between the main part and the activation part.

9. The foodstuff comminution system according to claim 8, wherein
a. the fastening portion is fittable into the receptacle in a form-fitting and/or latching manner; or
b. the fastening portion is fittable into the receptacle in place of the cutter part in a form-fitting and/or latching manner.

10. The foodstuff comminution system according to claim 1, wherein the activation part has a press die which faces the main part.

11. The foodstuff comminution system according to claim 10, wherein the fastening portion has a frame fittable into the receptacle and in which frame the press die engages in a form-fitting manner when the additional comminution tool is in the operating position.

12. The foodstuff comminution system according to claim 1, wherein the additional comminution tool is securable on the foodstuff comminution device without the main part and/or the activation part having to be previously modified or separated from one another for securing the additional comminution tool on the food comminution device.

13. The foodstuff comminution system according to claim 1, wherein an external side of the activation part that faces away from the main part comprises the sliding track or the part of the sliding track.

14. The foodstuff comminution system according to claim 1, wherein the additional comminution tool has a further receptacle into which a cutter or grater insert is fittable in a non-destructive releasable and/or latching manner.

15. The foodstuff comminution system according to claim 14, wherein the cutter or grater insert has at least one mandolin slicer blade, or a plurality of Julienne blades, or a plurality of grater projections.

16. The foodstuff comminution system according to claim 14, wherein the foodstuff comminution system has a plurality of different cutter or grater inserts which are selectively fittable into the further receptacle.

17. The foodstuff comminution system according to claim 1, wherein the foodstuff comminution device has a coupling device for coupling the foodstuff comminution device to a container.

18. The foodstuff comminution system according to claim 17, wherein a container coupled to the foodstuff comminution device by the coupling device automatically catches foodstuff material comminuted by the foodstuff comminution device.

19. The foodstuff comminution system according to claim 1, wherein the additional comminution tool has a further coupling device for coupling the additional comminution tool to a container.

20. The foodstuff comminution system according to claim 19, wherein a container coupled to the foodstuff comminution device by the further coupling device automatically catches foodstuff material comminuted by the additional comminution tool.

21. The foodstuff comminution system according to claim 17, wherein the additional comminution tool has a further coupling device for coupling the additional comminution tool to a container, and wherein the coupling device and the further coupling device are of identical configuration.

22. The foodstuff comminution system according to claim 21, wherein the foodstuff comminution system comprises at least one container capable of being coupled selectively to the foodstuff comminution device by the coupling device, or to the additional comminution tool by the further coupling device.

23. The foodstuff comminution system according to claim 1, wherein the foodstuff comminution device is configured as a hand-held apparatus which, in a comminution procedure, is configured and specified for being held by hand or by hands without being set down on a worktop.

24. The foodstuff comminution system according to claim 23, wherein the main part has a first handle part and the activation part has a second handle part, both the first and second handle parts being disposed so as to be collectively encompassed and mutually compressible by the fingers of one hand.

25. The foodstuff comminution system according to claim 1, wherein the additional comminution tool has a support foot arranged to support the additional comminution tool on a worktop, whereby in a comminution procedure a foodstuff material to be comminuted is guided by one hand back and forth on the sliding track while the foodstuff comminution device situated in the closing position is simultaneously freely held by the other hand.
